(19) United States
(12) Patent Application Publication
(10) Pub. No.: US 2016/0026934 A1
(43) Pub. Date: Jan. 28, 2016

(54) MOBILE APPLICATION FOR FACILITATING TRANSACTIONS BETWEEN PEOPLE IN PHYSICAL QUEUES

(71) Applicant: EHUD MERHAV, Sebastopol, CA (US)

(72) Inventor: EHUD MERHAV, Sebastopol, CA (US)

(21) Appl. No.: 14/337,715

(22) Filed: Jul. 22, 2014

(51) Int. Cl. G06Q 10/02; G06Q 30/06

(52) U.S. Cl. CPC G06Q 10/02; G06Q 30/0601

(57) ABSTRACT

The invention is concerned, generally, with enabling individuals to connect and interact with one another in a physical line. In one embodiment, the mobile application offers the person with limited time an opportunity to exchange their location with another person in an advanced position in the same line who is willing to exchange time for money. The application renders a medium for safely and efficiently exchanging a physical location in a line of people waiting for a good or service. In another embodiment, individuals can connect with others in line based on in-person identification and interest, such as for dating.

### CROSS-REFERENCE TO RELATED APPLICATIONS

None

### FEDERALLY-SPONSORED RESEARCH

Not applicable.

### SEQUENCE LISTING

Not applicable.

### BACKGROUND OF THE INVENTION

The invention is concerned, generally, with enabling individuals to connect and interact with one another in a physical line. More specifically, the present invention provides a mechanism for managing the exchange, between strangers, of time involved in waiting in line for a monetary reward. Additionally, the present invention provides a mobile application environment for mutually interested (or mutually attracted) individuals to connect and communicate.

It is indisputable that American's commit copious waste of increasingly valuable time waiting in line. According to various modern statistics, Americans spend roughly 37 billion hours a year waiting in lines, which is between two to three years of each individual life. Lines, or queues, are common sources of downtime in everyday modern life, particularly in urban centers and transportation hubs. People wait in line for everything from restaurant seating to various airport queues to theme parks and grocery stores. Some people standing in line have more time—and perhaps more patience—than others standing in the same line. Presently there is no mechanism or marketplace for people standing in line enabling the exchange of time for money or, conversely, money for time. There is, however, a present need for this exchange.

Presently there is no opportunity for an individual to have a brief economic or other type of transaction with an unknown, unrelated individual standing in the same line. People in advanced positions at the head of the line have no opportunity to offer their location in exchange for a monetary reward for those pressed for time toward the end of the line. Conversely, a person at the end of the line, and who is in a great hurry, has no opportunity to offer a monetary incentive in exchange for swapping a line position closer to the head of the line.

There exist various types of queue informational and management applications, but none offer the opportunity to facilitate a location exchange in a physical line. The disclosure of U.S. Publication No. US-2007/0140222 A1—“Facilitating the Exchange of a Position on a Waiting List”—for example, enables position swapping between computer users for goods or services for which there is a virtual (online) waiting list. ZipLine, Line Snob and Walo, for example, are mobile applications that give a user a sense of how long a line might be and when is the best time to join the line but does not enable any kind of position exchange. Another available queue “solution” is Qless, which is sold to service providers to allow customers to wait in line without being physically in a line. Similarly, the system disclosed in U.S. Pat. No. 5,987,421—“Computerized System and Method for Locating Individual Members of Discrete Groups and for Electronically Registering and Holding the Group's Position in Waiting Lines”—enables amusement parks or similar establishments to register a patron's position in line for, as an example, a ride without requiring the patron to physically stand in line. These products are not available to consumers and does not contain the position swapping capability.

Likewise, there exist location-based dating applications, such as Tinder and MeetMoi, which connect people based on personal settings (e.g., gender, age, etc.) and geographic location. There presently exists, however, a further need for individuals to connect with others in real time based on in-person identification and interest. The new mobile application enables such connection.

### SUMMARY OF THE INVENTION

The current invention is a mobile application that offers the person with limited time an opportunity to exchange their position with another person in an advanced position in the same line who is willing to exchange time for money. The application renders a medium for safely and efficiently exchanging a physical position in a line of people waiting for a good or service. Through built-in logic and user input (crowd sourcing) to drive algorithms, a line profile will be established to facilitate a transaction. The technology will allow for relative position deduction in a line and will allow the person giving up their location at the head of the line or in an advanced position in the line to move to the end or a less advanced position in the line. A “position signature” technology will facilitate location swapping between the “position buyer” and “position seller”. Such position signature technology will help avoid potential conflicts and confusion when swapping locations in the middle of the line. For the first time, unfamiliar persons can quickly execute a transaction where money is exchanged for time waiting in a physical line. Swapping prices will be determined by “market forces” within the line.

Alternatively, the new mobile application can be used to connect one interested person with another interested person in real time. An example scenario follows: A man—Person 1 stands in line at an airport and is logged into the mobile application (or mobile application network). Person 1 sees that others are logged in as well. Person 1 creates a short dating profile or enables a previously created profile to be revealed/accessible to others who are logged in. Person 1 indicates through the application that he has time for coffee before his flight. Person 1 sees an attractive woman—Person 2—several positions up or down from him in the line. To Person 1's delight he sees that she, too, has exposed her profile and is interested in making a real-time connection. Through the application, Person 1 brings his profile to her attention. To his further delight, Person 2 reads Person 1's profile, ascertains his position in line and turns her head to see him. Through the application, Person 2 indicates that she is interested in connecting with Person 1. They are then able to communicate through the mobile application user interface.

The sum of these advantages unify with the novel method of managing the exchange of time in a physical line for money or connecting people in real-time for social purposes, resulting in an invention that is not anticipated, rendered obvious, suggested, or even implied by any of the prior art support, either alone or in any combination thereof.

These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. For example, the new mobile application could be used to connect individuals in parking lots or spaces interested in paying or receiving a monetary reward for obtaining or giving up a parking spot, respectively. Another example is facilitating a communication between a crowd of strangers at an event where people are able to find shared rides after the event is over. It should be further understood that the phraseology and terminology applied herein merely serve the purpose of description and should not be regarded as limiting.

### BRIEF DESCRIPTION OF THE DRAWING(S)

FIG. 1 diagrams the “no-bidding” embodiment of the mobile application for connecting people in a physical queue.

FIG. 2 diagrams the “bidding” embodiment of the mobile application for connecting people in a physical queue.

FIG. 3 diagrams the “batch swapping” embodiment of the mobile application for connecting people in a physical queue.

FIG. 4 diagrams the “matching” embodiment of the mobile application for connecting people in a physical queue.

### DETAILED DESCRIPTION OF THE INVENTION

In accordance with this invention, it is now possible for a person standing in line to conveniently swap position with another person in line in exchange for a monetary reward and for people to conveniently connect in real time based on a live visual impression buttressed by succinct profile.

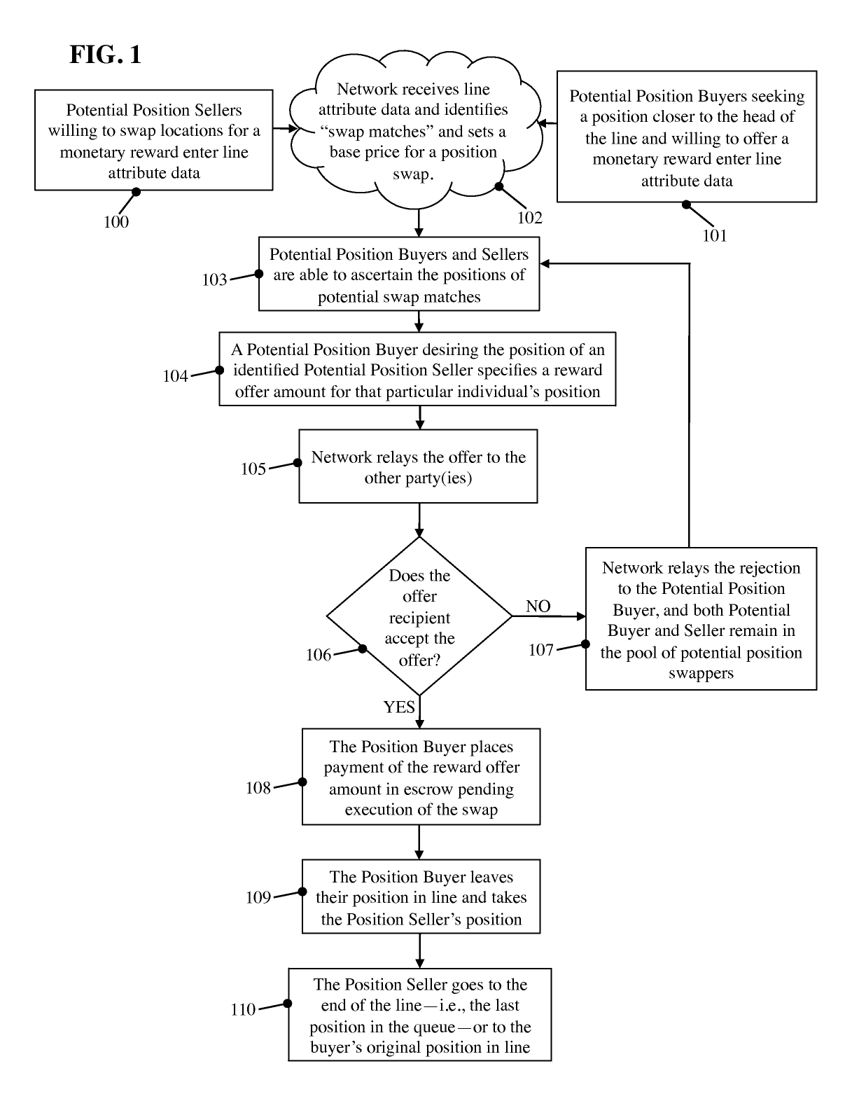

FIG. 1 diagrams the “no-bidding” embodiment of the mobile application for exchanging positions in a physical queue. The no-bidding scenario occurs where there is an equal number of position sellers to position buyers.

Initially, multiple individuals and/or groups are standing in line for a good or service. Potential Position Sellers—those in a relatively more-favorable position in line—who are willing to swap locations for a monetary reward enter “line attribute data” into the mobile application interface 100. Line attribute data includes information such as the individual's location in line, number of people in the line, anticipated wait time, etc. Potential Position Buyers seeking a position closer to the head of the line and willing to offer a monetary reward enter line attribute data into the mobile application interface 101. The mobile application network receives line attribute data from Potential Position Buyers and Sellers, identifies “swap matches” based on the relative locations of the Potential Buyers and Sellers, and sets a base price for a potential swap 102. The base price may be determined by factors such as wait time, number of people in line, market demand, geographic location, type of line (i.e., the good or service being sought), the Potential Position Buyer's sense of urgency and/or the application host's fee for managing the position swap. Potential Position Buyers are able to ascertain the positions of Potential Position Sellers with whom they have matched 103. This may be accomplished by making visual contact with each other—e.g., through waving, identifiers such as clothing and hair color, etc.—or via listing or graphical representation in the application itself or via blocked phone calls for those participants that include a mobile phone number as part of their user profile. An offer is then made: a Potential Position Buyer can specify a reward offer amount above the base rate for a particular Potential Position Seller's position, or a Potential Position Seller can specify a desired reward amount above the base rate 104. The mobile application network relays the offer to the other party(ies) 105. The network determines whether the offer recipient accepts or rejects the offer 106. If the Potential Position Seller rejects the offer, the network relays the rejection to the Potential Position Buyer, and both Potential Buyer and Seller remain in the pool of potential position swappers 107. If the Potential Position Seller accepts the offer, the Position Buyer places payment of the reward offer amount in escrow pending execution of the swap 108. The Position Buyer then leaves his position in line and takes the position of the Position Seller 109. The Position Seller then goes to the end of the line—i.e., the last position in the queue—or to the buyer's original position in line, depending on the specific system technology being employed 110.

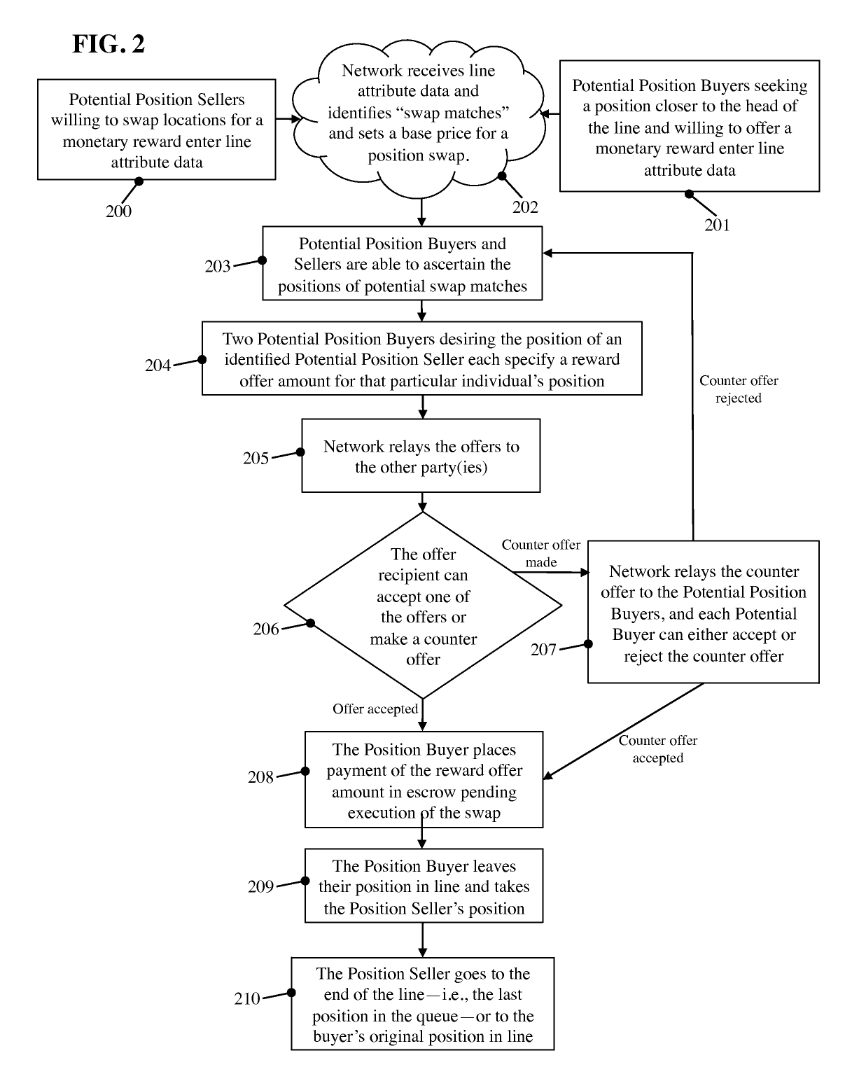

FIG. 2 diagrams the “bidding” embodiment of the mobile application for exchanging positions in a physical queue. The bidding scenario occurs where there are more location buyers than location sellers, and after a reserve price has been determined the monetary reward is determined by the market price point for the location swap.

Initially, multiple individuals and/or groups are standing in line for a good or service. Potential Position Sellers who are willing to swap locations for a monetary reward enter line attribute data into the mobile application interface 200. Potential Position Buyers seeking a position closer to the head of the line and willing to offer a monetary reward enter line attribute data into the mobile application interface 201. The mobile application network receives line attribute data from Potential Position Buyers and Sellers, identifies “swap matches” based on the relative locations of the Potential Buyers and Sellers, and sets a base price for a potential swap 302. The base price may be determined by factors such as geographic location, market demand, type of line (i.e., the good or service being sought), the Potential Buyer's sense of urgency and/or the application host's fee for managing the position swap. Potential Position Buyers are able to see the positions of Potential Position Sellers with whom they have matched 203. Two Potential Position Buyers desiring the position of an identified Potential Position Seller each specify a reward offer amount for that particular individual's position 204. The mobile application network relays the offer to the other party(ies) 205. The network determines whether the offer recipient accepts or rejects one of the offers 206. If the Potential Position Seller rejects both the offers, the network relays the counter offer to the Potential Position Buyers, and each Potential Buyer can either accept or reject the counter offer 207. If the Potential Position Seller accepts one of the offers, the Position Buyer places payment of the reward offer amount in escrow pending execution of the swap 208. The Position Buyer then leaves his position in line and takes the position of the Position Seller 209. The Position Seller then goes to the end of the line—i.e., the last position in the queue—or to the buyer's original position in line, depending on the specific system technology being employed 210.

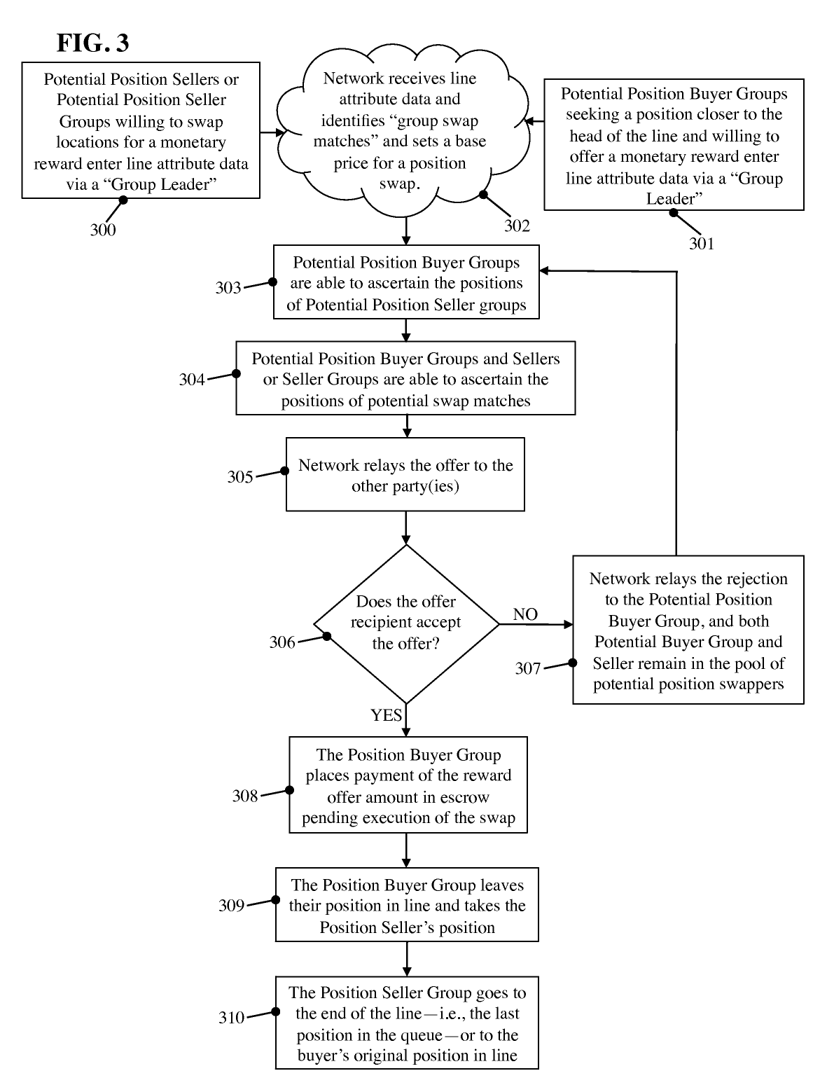

FIG. 3 diagrams the “batch swapping” embodiment of the mobile application for exchanging positions in a physical queue. The batch swap scenario occurs where a group of people at the beginning of the line—e.g., family or friends—seek to swap a location in the line with the same number of people at an advanced position in the line.

Initially, unrelated individuals and/or groups are standing in line for a good or service. Potential Position Sellers who are willing to swap locations for a monetary reward enter line attribute data into the mobile application interface 300. Potential Position Seller Groups willing to swap locations for a monetary reward enter line attribute data via a “Group Leader” into the mobile application interface 301. A “group” is two or more individuals who wish to remain—or swap positions—in line together. The Group Leader is simply one member of the group acting on behalf of the group with respect to the potential position exchange. Here, line attribute data includes information such as the individual's location in line and the number of group members either looking to buy an advanced position in the line or who are willing to sell their position in the line. Potential Position Buyer Groups seeking a position closer to the head of the line and willing to offer a monetary reward enter line attribute data via a Group Leader. The mobile application network receives line attribute data from Potential Buyers and Sellers, identifies “swap matches” based on the relative locations of the Potential Buyers and Sellers, as well as group size, and sets a base price for a potential swap 302. Potential Position Buyer Groups are able to ascertain the positions of Potential Position Sellers and Seller Groups with whom they have matched 303. Here, the matched “Potential Seller Group” could be a group of the same size as that of the Potential Buyer Group or a combination of groups and/or individuals in contiguous, sequential positions in the line. A Potential Position Buyer Group desiring the position of an identified Potential Position Seller Group specifies a reward offer amount for that particular group's position 304. The mobile application network relays the offer to the other party(ies) 305. The network determines whether the offer recipient(s), in whole, accepts or rejects the offer 306. If the Potential Position Seller Group—or any portion thereof—rejects the offer, the network relays the rejection to the Potential Position Buyer Group, and both Potential Buyer and Seller remain in the pool of potential position swappers 307. If the Potential Position Seller Group accepts the offer, in whole, the Position Buyer group leader places payment of the reward offer amount in escrow pending execution of the swap 308. The Position Buyer Group then leaves their position in line and takes the position of the Position Seller Group 309. The Position Seller Group then goes to the end of the line—i.e., the last position in the queue—or to the Buyer Group's original position in line, depending on the specific system technology being employed 310.

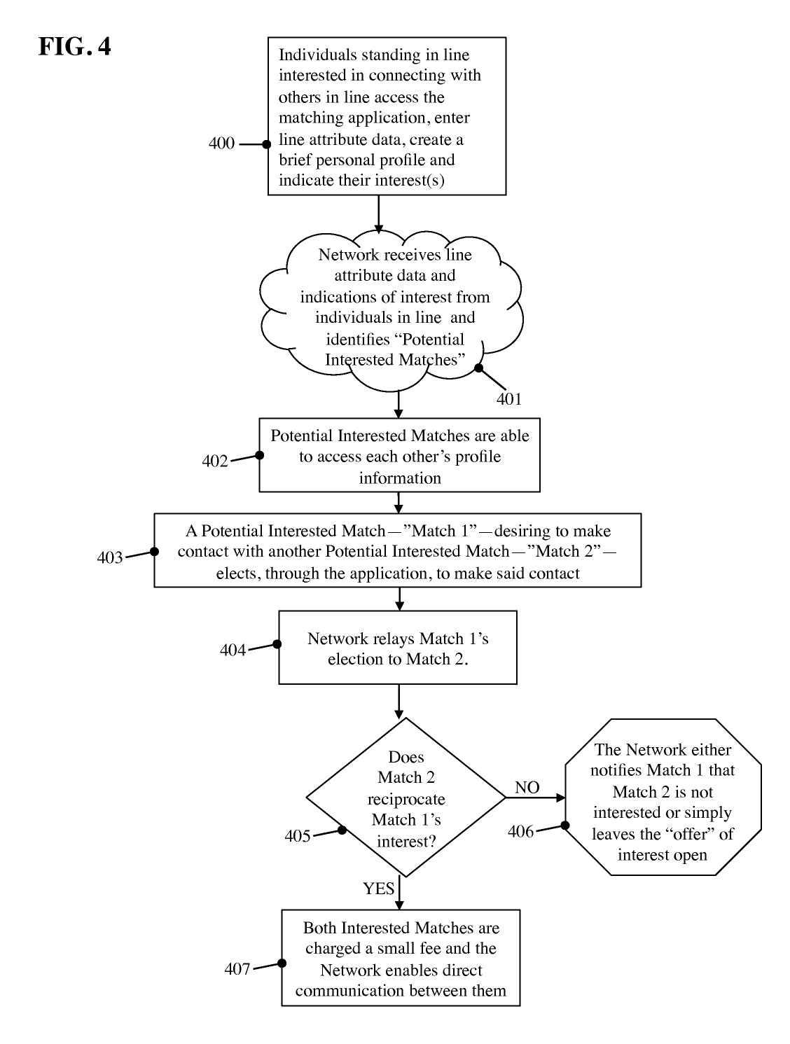

FIG. 4 diagrams the “matching” embodiment of the mobile application for connecting people in a physical queue. Matching occurs when two individuals standing in a line are interested in communicating—such as for the purpose of dating—and then connect through the new mobile application. In practice, individuals standing in line interested in connecting with others in line access the matching application, enter line attribute data, create a brief personal profile and indicate their dating interest(s)—i.e., whether they are interested in dating in general, whether there is someone in line in particular with whom they would like to connect, etc.—or elect to expose a previously created profile 400. The mobile application network receives the line attribute data and indications of interest from individuals in line and identifies “Potential Interested Matches” 401. Potential Interested Matches are able to access each other's profile information 402. A Potential Interested Match—“Match 1”—desiring to make contact with another Potential Interested Match—“Match 2”—elects, through the application, to make such contact 403. The Mobile Application Network relays Match 1's election to Match 2 404. Match 2 then has the option of indicating reciprocation of Match 1's interest in connecting 405. If Match 2 does not reciprocate Match 1's interest, the Network either notifies Match 1 that Match 2 is not interested or simply leaves the “offer” of interest open 406. If Match 2 does indicate reciprocation of interest, both Interested Matches are charged a small fee and the Network enables direct communication between them 407.

As to further discussion of the manner of usage and operation of the present invention, the same should be apparent from the above description. With respect to the above description then, it is to be realized that the optimum relationships of the steps of this invention, to include variations in technological enablement, are deemed readily apparent and obvious to one skilled in the art, and all equivalent relationships to those illustrated in the drawings and described in the specification are intended to be encompassed by the present invention, the use of which results in a method for managing the exchange of time in a physical line for a monetary reward.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided.

1. A method for electronically connecting people in a physical queue comprising:
providing a network capable of access via the Internet, said network being capable of receiving, analyzing and transmitting data;
providing a mobile application capable of installation and use on mobile devices, including smart phones and tablet devices, capable of connecting to the interne;
providing a mobile application user interface accessible by positioned individuals in a physical queue waiting for a good or service, said user interface allowing positioned individuals to log into the mobile application and, thus, connect to the network;
providing for input of line attribute data through the user interface by individuals waiting in a physical queue and providing for receipt of said line attribute data by said network; and
building a virtual representation of a real-time physical queue, including the positions of positioned individuals who are logged into the mobile application.

2. The method of claim 1 further comprising generating a location signature, which notes an individual's original position in a physical queue.

3. The method of claim 1 further comprising receiving specific communication(s) from positioned individuals and transmitting said requests to the intended recipients.

4. The method of claim 3 wherein said specific communication(s) are one or more of those in the list comprising: requesting a position closer to the front of the physical queue, offering to give up one's position in a physical queue, offering a specified monetary reward amount for procuring or giving up one's position in a physical queue, making available one's interest in connecting with another individual in a physical queue, and requesting to connect with a specific individual in a physical queue.

5. The method of claim 1 further comprising providing for communication via the user interface between positioned individuals in a physical queue.

6. The method of claim 1 further comprising providing for payment by positioned individuals and receipt of said payment by the mobile application network.

7. A method for enabling the exchange of positions in a physical queue comprising:
providing a network capable of access via the Internet, said network being capable of receiving, analyzing and transmitting data;
providing a mobile application capable of installation and use on mobile devices, including smart phones and tablet devices, capable of connecting to the interne;
providing a mobile application user interface accessible by positioned individuals in a physical queue waiting for a good or service, said user interface allowing positioned individuals to log into the mobile application and, thus, connect to the network;
providing for input of line attribute data through the user interface by individuals waiting in a physical queue and providing for receipt of said line attribute data by said network;
building a virtual representation of a real-time physical queue, including the positions of positioned individuals who are logged into the mobile application;
receiving a request through the user interface from a positioned individual buyer for an advanced position in the queue—i.e., a position closer to the head of the line;
receiving an offer through the user interface from a positioned individual seller for exchanging said individual's position for a monetary reward;
receiving a monetary reward amount offer from either the positioned individual buyer or seller and transmitting said monetary reward amount offer to the positioned individual buyer or seller, whomever is the intended recipient of said offer; and
receiving notification of acceptance of a monetary reward amount offer from either the positioned individual buyer or seller, thus confirming a position swap, and relaying notification of said position swap to both positioned individuals.

8. The method of claim 7 further comprising providing for network generation of a base rate to be paid by a positioned individual buyer to the mobile application network upon confirmation of a position swap.

9. The method of claim 7 further comprising providing for payment of the base rate by positioned individual sellers and receipt of said payment by the mobile application network.

10. The method of claim 7 further comprising:
providing for payment of the monetary reward offer amount by positioned individual sellers and receipt of said payment by the mobile application network;
providing for the retention of said amount to be held by the network in escrow;
enabling input through the user interface by the positioned individual buyer and/or seller confirming completion of the position swap; and
providing for release of the monetary reward offer amount to the positioned individual seller.

11. The method of claim 7 wherein said positioned individual buyer is a single person or a group of two or more persons.

12. The method of claim 7 wherein said positioned individual seller is a single person or a group of two or more persons.

13. A method for enabling electronic communication between mutually interested persons in a physical queue comprising:
providing a network capable of access via the Internet, said network being capable of receiving, analyzing and transmitting data;
providing a mobile application capable of installation and use on mobile devices, including smart phones and tablet devices, capable of connecting to the internet;
providing a mobile application user interface accessible by positioned individuals in a physical queue waiting for a good or service, said user interface allowing positioned individuals to log into the mobile application and, thus, connect to the network via the internet;
providing for creation of a user profile through the user interface by positioned individuals;
providing for input of user input data by positioned individuals via the mobile application user interface, including selective activation of the user profile by a first positioned individual and indication of interest in a second positioned individual in the physical queue, and for receipt of user input data by the network;
providing for relaying of the indication of interest by the first positioned individual to the second positioned individual in the physical queue via the mobile application user interface and for receipt of the indication of interest by the second positioned individual via the mobile application user interface;
providing for reciprocal indication of interest by the second positioned individual through the mobile application user interface and for receipt of the reciprocal indication of interest by the network; and
providing for direct electronic communication through the network between the first positioned individual and the second positioned individual via the mobile application user interface.

14. The method of claim 13 further comprising the steps of providing for input of line attribute data through the user interface by individuals waiting in a physical queue and providing for receipt of said line attribute data by said network; and providing for building a virtual representation of a real-time physical queue, including the positions of positioned individuals who are logged into the mobile application.

15. The method of claim 13 wherein the indication of interest or reciprocal indication of interest might be an electronic message or other means of relaying interest in a specific individual to the network.

16. The method of claim 13 further comprising providing for network generation of a base rate to be paid by a positioned individual buyer to the mobile application network upon confirmation of mutual—or reciprocated—interest.

17. The method of claim 13 further comprising providing for payment of the base rate by positioned individual sellers and receipt of said payment by the mobile application network.

18. The method of claim 13 further comprising the step of providing for network confirmation of reciprocated interested before providing for direct electronic communication through the network between the first positioned individual and the second positioned individual via the mobile application user interface.

19. The method of claim 13 further comprising providing for a blocking means whereby a concerned positioned individual can block—or prevent—another positioned individual from viewing the concerned positioned individual's active profile, position in the physical queue and any additional information associated with the concerned positioned individual's mobile application account.
